(19) United States
(12) Patent Application Publication
(10) Pub. No.: US 2002/0059230 A1
(43) Pub. Date: May 16, 2002

(54) Asset control system and method

(75) Inventors: Johnnie L. Hunepohl, Sacramento, CA (US); Richard L. Drolet, Pleasanton, CA (US)

Correspondence Address: BEYER WEAVER & THOMAS LLP, P.O. BOX 778, BERKELEY, CA, 94704-0778, US

(73) Assignee: Capstone Technology, Inc.

(21) Appl. No.: 09/976,207

(22) Filed: Oct. 12, 2001

Related U.S. Application Data
(60) Provisional application No. 60/240,204, filed on Oct. 13, 2000.

(51) Int. Cl. G06F 7/00

(52) U.S. Cl. 707/6

(57) ABSTRACT

An add-on apparatus is provided for allowing pre-installed access control systems to act as asset management systems. This apparatus can make use of existing access control panels, networks, and sometimes access control system readers and other infrastructure. The readers receive periodic signals from active tags associated with particular assets. When an asset moves to a new location, the associated active tag emits a signal (one of the continual stream of periodic signals that it emits). That signal is detected by a nearby reader for the first time. The reader transmits information derived from the signal to the apparatus, which then changes state to indicate that the asset is now in its domain. This information is repackaged and sent to another component of the access/asset management system for appropriate action. Note that the apparatus continues to receive signals generated from the active tag while the asset is in close proximity to the reader. However, the apparatus does not transmit this information to other components of the system. The apparatus changes state once while the asset is under its jurisdiction. When it undergoes that state change, the apparatus sends an initial message to the access/asset management system. Thereafter it sends no updated message until the asset moves out of reach of its reader. Asset movement may be detected by a cessation of signals detected by the reader or by receipt of a new signal from a different reader (located at a door for example).

### CROSS-REFERENCE TO RELATED APPLICATIONS

This application claims priority under U.S.C. 119(e) from U.S. Provisional Application No. 60/240,204, entitled “Asset Control System and Method,” as of filing on Oct. 13, 2000, the disclosure of which is herein incorporated by reference for all purposes.

### BACKGROUND OF THE INVENTION

This invention relates to asset control systems and methods of tracking assets. More specifically, this invention relates to asset control systems and methods that employ active tags to track and control assets.

Various systems have been proposed to automatically and inobtrusively track and control movement of assets. Many of these are complete asset control systems that provide all components and infrastructure required for asset management. Unfortunately, these systems suffer from certain shortcomings. Most notably, such systems require numerous components, including special signal generators affixed to the asset, corresponding signal readers, hardware and software providing the logic to make decisions based upon the signals received, and wiring (and sometimes networks) for transmitting signals from the readers to the associated logic. Also, sophisticated asset control resources such as automatic locking doors or gates may be required. In all, the cost and effort required to obtain an install such “end-to-end” systems can be a bar to all but the most highly capitalized and security-conscious enterprises.

The need for asset control is not limited large well-funded companies. Schools, day care centers, and other child care centers must each keep close track of the location of individual children. Note that in this context, children can be viewed as the “assets” that require tracking and control. Other assets of interest include automobiles, computers, conference telephones, and the like. A valet service or parking garage may need to track and control certain automobiles while in its custody. A large company with mobile employees may have to track its laptop computers. These are just a few of the assets and associated enterprises for which asset control systems would be desirable.

As mentioned, various asset control systems have been proposed. One such system is the Eagle Eye Direct available from Versus Company of Traverse City, Mich. This system includes readers, active tags, computers, and wiring for allowing communication between the readers and the asset management logic/software. A user is required to purchase all these specialized components in order to implement the access control system. As mentioned, this may be fine for some customers but not others.

Another asset control system has been proposed by AIT Company of South Africa. This system makes use of existing infrastructure for access control systems. Many companies have in the past invested in such access control systems to prevent individuals (as opposed to assets) from entering or leaving particular locations without appropriate electronic authorization. Such authorization might be provided via a badge or other electronic signal generator carried by a person. The person swipes the tag through or by a reader, which recognizes the signal. The system then provides access to certain resources. For example, the system may provide access to a particular room by unlocking a door or provide access to an executive floor of a hotel by unlocking elevator access to the floor.

The AIT system provides an add-on product that recognizes periodic signals from an active tag associated with an asset of interest. Upon receipt of each periodic signal, the AIT system forwards information to the access control system. The system is then expected to take appropriate action with regard to the resources that it controls. Unfortunately, such access control systems are not designed to work with active tags. The continual receipt of new signals can flood the access control system and cause it to enter improper states or otherwise malfunction. Note that most access control systems are designed to work with passive tags that emit signals only when probed. Thus, they do not continually issue new signals.

What is needed therefore is an inexpensive and simple system that automatically and inobtrusively tracks and controls movement of assets.

### SUMMARY OF THE INVENTION

The present invention meets this need by providing an improved add-on apparatus (and associated method) for use with pre-installed access control systems. This product, sometimes referred to herein as a “converter/controller,” can make use of existing access control panels, networks, and sometimes access control system readers and other infrastructure. The readers receive periodic signals from active tags associated with particular assets. When an asset moves to a new location, the associated active tag emits a signal (one of the continual stream of periodic signals that it emits). That signal is detected by a nearby reader for the first time. The reader transmits information derived from the signal to the converter/controller, which then changes state to indicate that the asset is now in its domain. This information is repackaged and sent to another component of the access/asset management system for appropriate action. Note that the converter/controller continues to receive signals generated from the active tag while the asset is in close proximity to the reader. However, the converter/controller does not transmit this information to other components of the system. The converter/controller changes state once while the asset is under its jurisdiction. When it undergoes that state change, the converter/controller sends an initial message to the access/asset management system. Thereafter it sends no updated message until the asset moves out of reach of its reader. Asset movement may be detected by a cessation of signals detected by the reader or by receipt of a new signal from a different reader (located at a door for example).

One aspect of this invention pertains to a method of providing asset control. The method may be characterized as follows: (a) receiving a signal initiated from an active tag associated with an asset (e.g., attached to the asset); (b) transitioning to a state indicating that the asset is at a particular location; and (c) sending a message in a format that can be understood by an access control system. The message indicates that the asset is at the particular location. Preferably, this method is implemented in an add-on apparatus for an asset control system.

Subsequently, the asset may be moved to a different location. The method of this invention may be extended to cover this event as follows: (d) determining that the asset is no longer in the particular location; (e) transitioning to a state indicating that the asset is no longer in the particular location; and (f) notifying the access control system that the asset is no longer in the particular location. In many embodiments, an access control panel is the component of the access control system that will be notified that the asset has moved into or out of the particular location.

Typically, an active tag is a device that emits a signal periodically. The signals from the active tag are relayed by a reader located close to the particular location. In many conventional systems, the signal is provided in the form of a packet containing information specifying at least (i) a unique identity of the active tag and (ii) a count indicating the number of times that the active tag has emitted a signal. Of course, other information may be provided additionally. Further, the information need not necessarily be provided in a packet format.

In a preferred embodiment, transitioning to a state indicating that the asset is at a particular location involves creating and storing a record of the asset or otherwise changing an internal characterization of the asset. As long as the system receives active tag signals from the local reader, the system maintains the same state. Thus, the method may involve resetting a time to live value in the record each time it receives a new signal initiated from the active tag. Preferably the access control system is notified only once while the asset is in the particular location, even though it may receive multiple signals from the active tag. That notification, which indicates that the asset is in the particular location, may comprise a message indicating an access event (e.g. a tag ID presented via a port associated with a given reader). The message is provided in a format that is recognized by the access control system (e.g., the Wiegand format).

When the asset moves from the location, the state changes again. In one embodiment, this involves removing a record of the asset or changing an internal characterization of the asset. The logic for determining that the asset is no longer in the particular location may involve detecting at least one of (i) a change in the signal from the active tag, and (ii) receipt of a new signal from the active tag. The new signal is of interest because a reader at a different location conveys it. Thus, the new signal indicates that the asset has moved, or is moving, to a new location. In addition (or alternatively), failure to receive the signal initiated from the active tag for more than a predetermined period of time may indicate that the asset is no longer in the particular location.

Another aspect of the invention relates to an apparatus for managing assets. Such apparatus may be characterized by the following features: (a) an input interface including at least two ports arranged to receive signals originating with an active tag; (b) an output interface arranged to transmit asset events indicating the state of an asset with respect to a particular location; and (c) a logic device that acts on the signals originating with the active tag to transition between a first state indicating that the asset is not located at the particular location and a second state indicating that the asset is located at the particular location. Typically, the two ports of the input interface are arranged to receive signals detected by two distinct readers. This allows the logic device to distinguish between signals originating when the asset is at different locations (because the distinct readers are positioned at different locations). In an alternative embodiment a single input port could be provided at the input interface and each distinct reader could be identified by the type of signal provided.

As indicated the invention may be provided as an add-on board for an access control system. Therefore, the asset events are preferably provided in a format that can be understood by an access control system. Commonly, the signals originating from the active tag include information specifying at least (i) a unique identity of the active tag and (ii) a count indicating the number of times that the active tag has emitted a signal.

The apparatus may include a database or list identifying assets that are currently located at the particular location. The database or list may provide records including a first field for an asset ID or asset tag ID and second field for a time to live value. The database or list may provide an indication of the state associated with a particular asset. To this end, the logic device may transition to the second state by creating and storing a record of the asset or changing an internal characterization of the asset.

In a preferred embodiment, the apparatus includes a clock signal source providing a clock signal employed by the logic device to identify assets from which no signals have been detected within a predetermined period.

These and other features and advantages of the invention will be set forth below with reference to the associated figures.

### BRIEF DESCRIPTION OF THE DRAWINGS

The following detailed description will be better understood when viewed in conjunction with the drawings in which:

FIG. 1 represents a schematic of how the method and apparatus are integrated into an existing access control system to produce an asset management system.

FIG. 2 represents a schematic of the basic functional components of a converter/controller used in the invention.

FIG. 3A represents a flowchart of the logic processing of a packet of information from an active tag via a room detector (tag reader).

FIG. 3B represents a flowchart of the logic processing of a packet of information from an active tag via an exit detector (tag reader).

FIG. 3C represents a flowchart of the logic processing for aging of active tags in an asset management system.

FIG. 4 represents a simple database or list that may be employed to keep track of state in a converter/controller of this invention.

### DETAILED DESCRIPTION OF THE INVENTION

The method and apparatus of the invention as described with the accompanying figures serves to illustrate the preferred embodiment of the invention and is not intended to limit the scope of the invention. For example a described embodiment depicts tag detectors in rooms, but the detector could be located in any designated secure access area like a parking lot, playground, or stadium.

In the context of this invention, the term “asset” has its conventional meaning. However, the assets of most interest are those that are tangible and mobile. Generally, assets used with this invention are outfitted with a tag that emits a signal. Thus, the assets should be able to support a signal generating tag. Note that not all assets of this invention are personal property. For example, children may be viewed as assets for purposes of this invention. Examples of other assets contemplated by the present invention include vehicles such as trains, trucks, automobiles, bicycles, computers such as laptop computers, freight, inventory, and the like.

Systems of this invention generally rely on signals that can be detected by one or more readers. Usually, such signals are generated by the tag associated with the asset under consideration. Typically, the tag will take the form of a card or other tangible device that can be attached or otherwise associated with the asset. While such devices may take many different forms and functions, they will be generally referred to as “tags.” The emitted signals may be any form of electromagnetic radiation or a field. Examples include infrared radiation, radio frequency radiation, magnetic fields, and the like. The devices may be active or passive. Active devices have their own power source (e.g., a battery) and emit signals without being probed. Passive devices, in contrast, emit signals only when probed by radiation or a field. For example, some passive devices respond to radio frequency probes of a particular frequency and power.

In preferred embodiments, the tags of this invention are “active tags.” Generally, such tags emit signals periodically; e.g., every few seconds or minutes. Some such tags may change the timing at which they emit signals depending upon conditions. Examples of active tags suitable for use with this invention include tags produced by HID of Traverse City Mich. and AIT of South Africa.

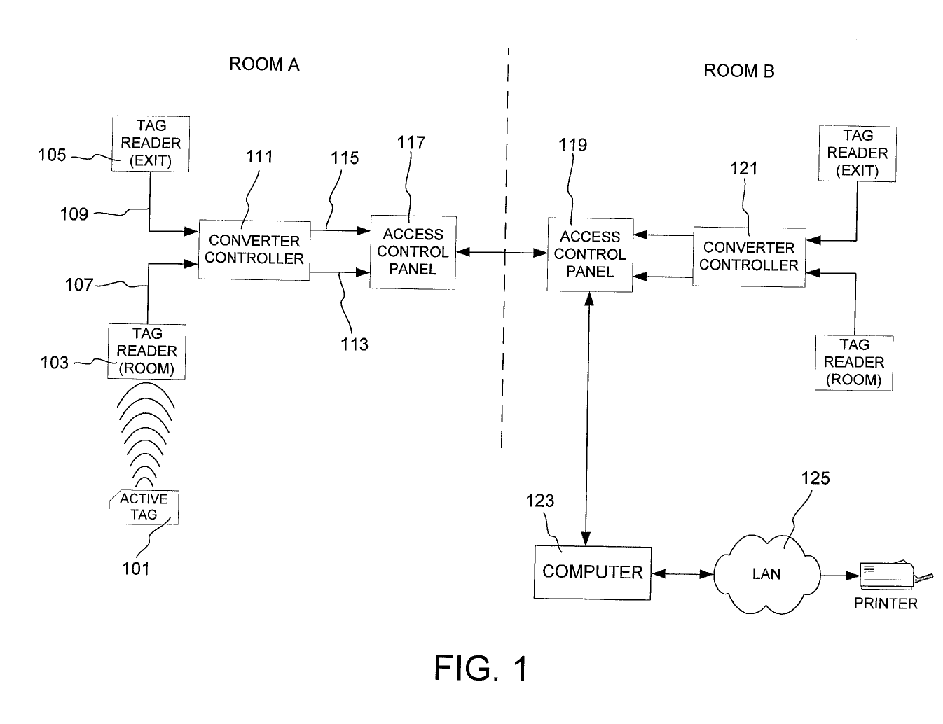

This invention may be used for managing the location of assets in a building for instance. The following specific embodiment is set in the context of an access control system. As used herein, the term “access control system” refers to systems that are used to provide access to particular resources (or combinations of resources) such as door locks, elevators, parking garage entrances, exits, etc. Generally, though not necessarily, such systems include or designed for use with readers; such as “swipe” readers, which detect signals from tags when those tags are presented to the readers. The systems also include logic and control subsystems that allow access when the appropriate signals are detected. In FIG. 1, much of the system constitutes a typical access control system. Examples of commercially available access control systems include Honeywell International of Morristown N.J., Motorola Incorporated of Schaumburg Ill., and Westinghouse Electric Company of Monroeville Pa. In principle, the invention can be implemented in a specially designed asset control system, but it finds particular value as an add-on to existing access control systems.

FIG. 1 depicts two rooms of a building, room A and room B. An asset is located in the room and affixed to or otherwise associated with an active tag 101. Tag 101 periodically emits a signal, often in data packet form. A detector or “reader” 103, also in room A, receives the signal from tag 101 due to its proximity to tag 101 and the range of the signal. In a doorway of room A there is an additional detector, tag reader 105. In one embodiment, reader 105 picks up the signal from 101 only when the asset is moved through the doorway. Signals received by tag readers 103 and 105 are sent to a converter controller unit 111, via lines 107 and 109 respectively. The converter controller unit independently converts data packets from 107 and 109 into an internal format, performs logic based on the data input, converts the resultant output to an access-control-system-readable format (such as Wiegand), and sends the data to an access control panel 117 via connections 113 and 115 respectively. Note, although only one active tag is depicted in this illustration, tag readers of the type described herein can accommodate multiple individual active tag signals. The invention, likewise can convert multiple data packets simultaneously.

An access control panel is a piece of hardware that acts as a resource control subsystem. Generally, access control panels serve to control particular resources associated with security and access. In many cases, access control panels are electronic devices for manipulating electromechanical devices such as door locks, elevators, or other resources and are typically used in commercial access control and security systems. Commonly these devices use Wiegand format for data input, although other formats may be suitable for use with this invention. Suitable access control panels for use with this invention include apparatus made by Honeywell International, Motorola Incorporated, and Westinghouse Electric Company.

Wiegand format is a standardized data transmission sequence and bit assignment used commonly for access control and security devices. In the preferred embodiment of the invention, the data packet is converted into this standardized format so that existing access control systems can interpret and use the data.

In the embodiment depicted in FIG. 1, data from tag readers 103 and 105 ultimately, after manipulation by unit 111, are delivered to access control panel 117 via connections 113 and 115, respectively. Also, there are commonly two input ports for the Wiegand data in an access control panel: the “Wiegand in” and “Wiegand out” ports. In this application, connection 113 feeds the Wiegand in port, and connection 115 feeds the Wiegand out port. In conventional access control systems, the Wiegand in port receives data from a reader used to gain entry to a room and the Wiegand out port receives data from a reader used to exit the room. In the present invention, the Wiegand in and out ports may also be used to provide data from two different readers. In the one embodiment, the first reader is located within a room, possibly on the ceiling of the room, while the second reader is located at the exit doorway to the room. The Wiegand in port receives data originating through the room reader and the Wiegand out port receives data originating through the exit door reader.

Access control panel 117 can be networked (e.g., daisy chained) to another access control panel 119, which may have its own associated converter controller 121 and associated tag readers in room B. In some cases, asset control may not be important in some regions of the network. When this is the case, the access control panel will communicate directly with the relevant tag readers, and there will be no converter controller. Many access control panels can be networked in this manner covering many rooms or areas in a particular building or setting. Any one or all of these can be connected to a computer, 123, which is used to program the access control panels, monitor activity in the system, and/or communicate with a LAN 125 to send data out, for example to a printer. Computer software for access control systems is provided by companies such as Checkpoint Systems, Incorporated of Thorofare N.J., and Simplex of Westminster Mass. Converter controller 111 represents a preferred embodiment of the invention. All other components described in FIG. 1 may be part of commercially available end-to-end access control systems or combined components of individual systems. In this embodiment, the invention is intended to be an interface between any commercially available active tag/reader system and access control system. That is, controller converter 111 may be designed or configured to interpret data from any active tag/reader system and convert it to a usable format for different access control systems. Active tags send out data packet signals on a predetermined regular basis. The controller converter, using its internal logic, evaluates the data each time it is sent. This allows for data to be sent to the access control panel only when appropriate and prevents the access control systems from being flooded with data.

The invention is a “smart system” in that active tag data is used to track and control asset movement. For example, as active tag 101 is moved out of room A, the exit tag reader 105 detects the signal, and after data manipulation via 111, the information is sent to access control panel 117. Upon receiving the signal, access control panel 117 can act according to its programming (or the programming of some other system component such as computer 123). It could lock an external door (when the particular asset is not supposed to leave the building), deliver an elevator to the floor that room A is on, or simply log the exit of the asset in a database.

Integral to enactment of the invention is “aging” of the active tag signal receipts. If a new signal has not been received from a particular reader within a given period of time, then it is assumed that the asset has moved. In a preferred embodiment, the logic of the controller converter uses an internal clock for setting time limits and intervals pertaining to received signals from active tags. If the signal from active tag 101 is blocked (for instance a potential thief hides an asset in a shielded container), then after a predetermined time limit the “aging” logic of controller converter 111 is programmed to send a signal to access control panel 117 for appropriate action. The system can detect and track active tag signals or the lack of signals, once a tag's identification data has been entered into the system (either from the active tag or preprogrammed).

Generally, access control panels receive messages that contain “access events.” Most simply, such events are represented as tag IDs that are associated with a particular reader. The association with a particular reader is based on the port through which the event is delivered. In other words, signals received from a first reader are sent through a first port in the access control panel and signals received from a second reader are sent through a second port in the access control panel. The access control logic receiving the access events then makes use of these events in any manner that is appropriate for the security concerns of the enterprise managing the assets and asset control system. Such logic may be programmed into an access control panel or other logic device such as a computer networked to other nodes on the access control system.

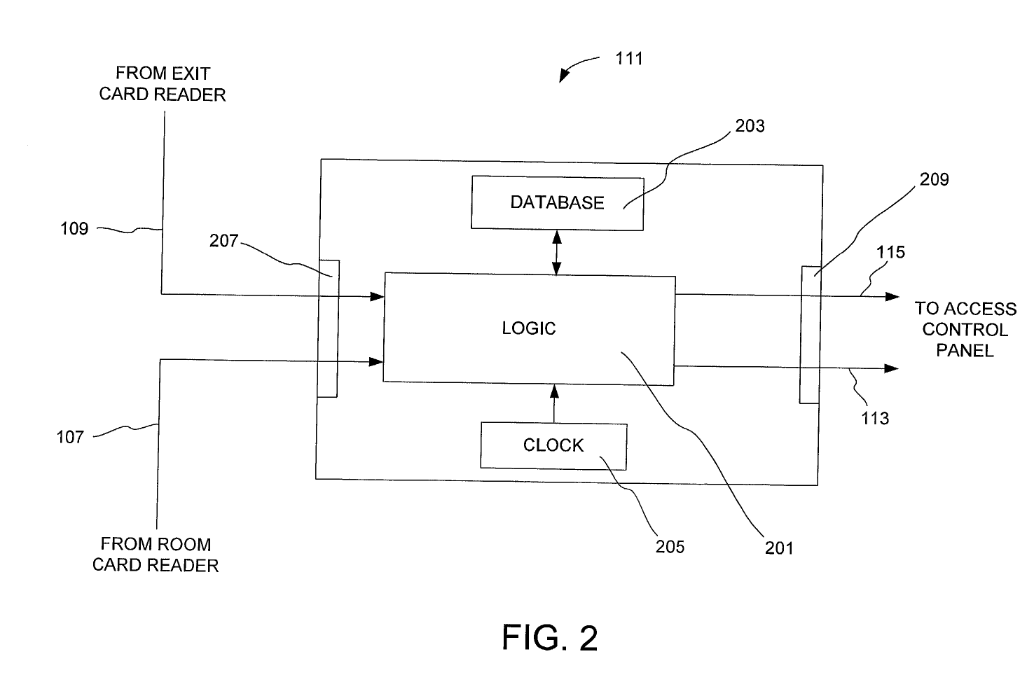

FIG. 2 diagrams some basic functional components that may be used in a converter controller of this invention. These components are chosen to allow the controller to serve its various functions. First, controller converter 111 often serves as a bridge between a commercially available active tag/reader system and an access control system. For example, signals from room and exit tag readers are received via connections 107 and 109 respectively. These inputs can be provided in any common format such as TCP/IP, for instance. Converter 111 includes an interface 207 including ports for lines 107 and 109. On the output side, converter 111 includes an interface 209 including ports for output lines 113 and 115.

Signals from individual readers are handled separately by a logic component 201 of controller converter 11. Data packets from connections 107 and 109 are interpreted by device 201 and used to determine the “state” of an asset. In a preferred embodiment, logic device 201 maintains the state of each asset that has recently entered its realm. Typically, that realm is the signal range of the various readers associated with the controller converter. In one example, an asset moves into the realm of the controller and the controller detects its presence. At that point, the controller logic device 201 transitions to a state indicating that the asset currently resides in its realm. Device 201 may note this state change by some internal configuration change. For example, it may write a particular value to a special register or it may create a record for a database or list. Such configuration change represents the state of interest. When that state changes, logic device 201 changes the relevant configuration to indicate a different state (e.g., it may change an internal characterization of the asset). In the example at hand, when the asset moves out of the realm of interest—as indicated by the cessation of periodic signals from a particular reader or the detection of a new signal from a different reader—device 201 transitions to a different state. In one example, such state change is indicated by deletion of a record or other indication of the first state.

In a preferred embodiment, logic device 201 judiciously sends messages for delivery via lines 113 and 115. For example, device 201 may detect repeated signals originating with the active tag (and detected by a single reader). However, device 201 remains in the same state and provides only a single message indicating that the asset is currently located at the particular location. In this manner the access control system, which is designed to handle only a single message each time an asset moves, receives information according to a protocol that makes sense to it.

When logic component 201 determines that a particular asset event should be communicated to the remainder of the system (via a message to access control panel 117, for example), it provides the necessary information in an appropriate format. Typically, the recipient of such an asset event will recognize only that data provided in a specified format. Many access control panels, for example, only recognize data presented in the Wiegand format. Thus, in this example, the logic component 201 generates messages in the Wiegand format.

In the example embodiment of this invention, messages indicating that an asset is in a particular location (e.g., the room) are sent through a connection 113 to the access control panel. Likewise, messages indicating that the asset is moving away from the location are sent through connection 115 to the access control panel.

Typically, the logic component 201 will be some form of electronic device such as a circuit board or an integrated circuit chip. In a particularly preferred embodiment, the logic component is a custom programmable device or ASIC such as a microcontroller, a field programmable gate array, or a programmable logic device. In a specific embodiment, logic device 201 is a specially programmed AT90S8515, available from Atmel Corporation of San Jose, Calif. The programming implements the logic for performing the operations needed to provide asset management. The logical flow described below is implemented on the microcontroller, for example.

In the depicted embodiment, logic component 201 uses an internal database 203 (described below) and clock 205. These components are used for storing tag ID information and aging active tags while in a particular state. A more detailed explanation of the logic performed on the signal data packets, database usage, and aging functions is presented below.

The database or list 203 may be provided as a simple file stored on memory associated with logic device 201. A separate memory chip or internal memory on device 201 may serve to house list or database 203. Similarly, clock 205 may reside externally or internally with regard to logic device 201. In a preferred embodiment, clock 205 is provided internally in the form of a separate crystal and oscillator, provided on one or two devices.

In one data conversion process the invention performs the following operations: (1) receive a packet of information from a reader via an active tag, (2) convert the packet to an internal format, (3) perform a logic operation using information from the packet, (4) generate an event message in a new external format, and (5) send the message to an access control system component which uses the external format.

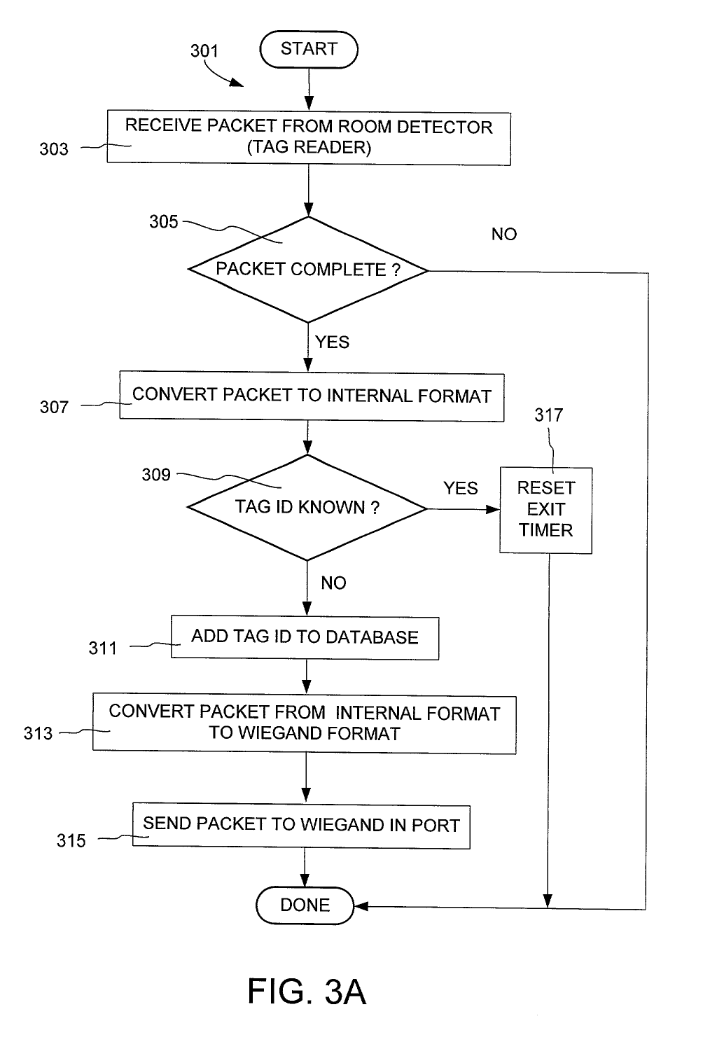

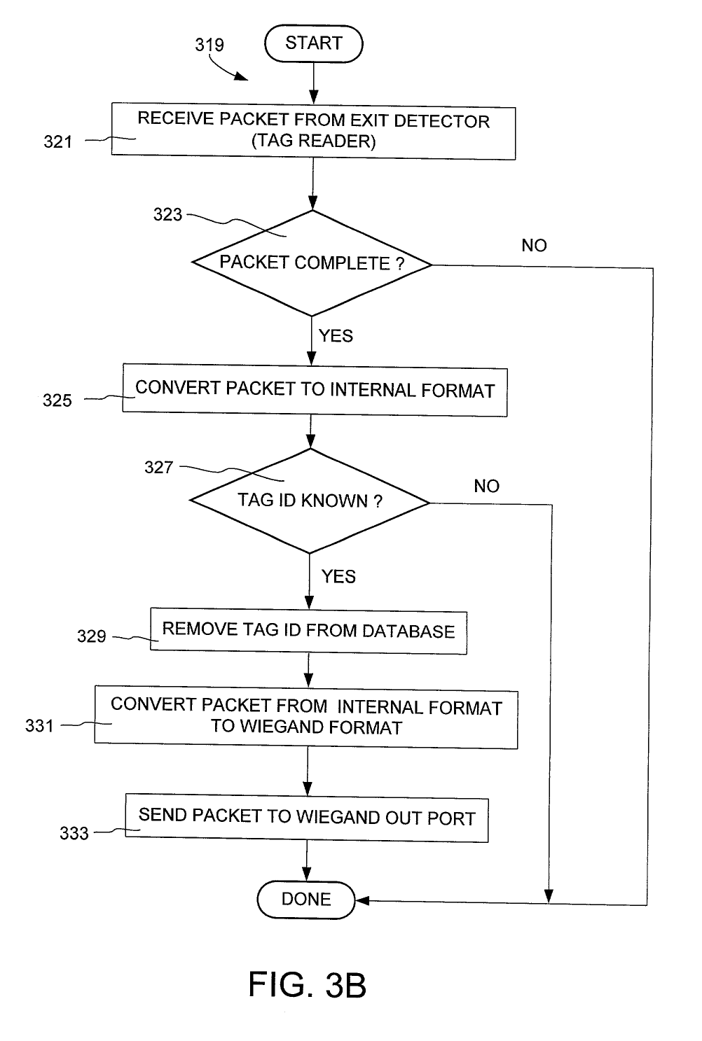

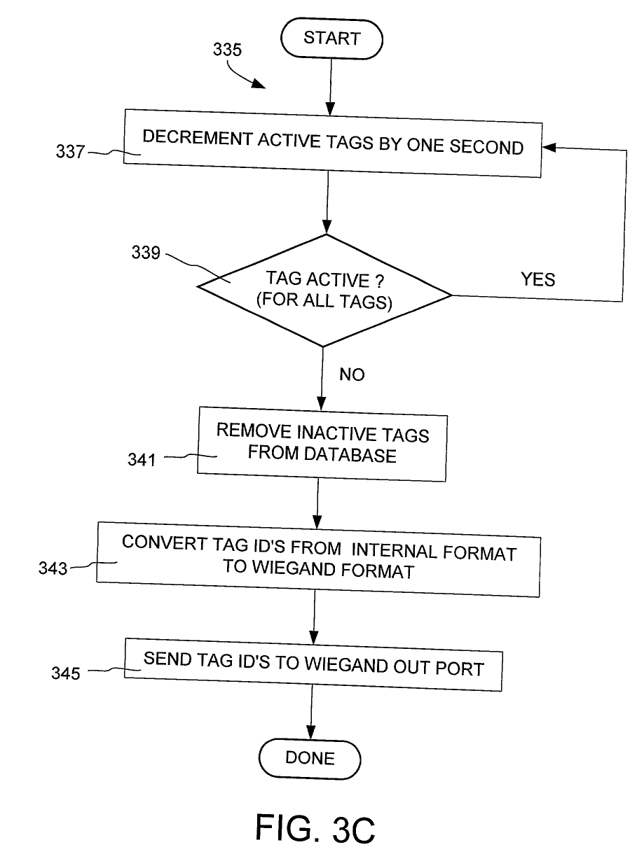

In a preferred embodiment, at least three processes may take place simultaneously for each asset within the realm of a given controller. The processes are depicted separately in FIGS. 3A, 3B, and 3C. Typically, these processes take place asynchronously.

FIG. 3A presents a flowchart of a logic process 301, in which a packet of information from an active tag is received by a first detector/reader (e.g., a room detector). See 303. Generally, the packet is analyzed to determine whether a state change should take place and a message should be output to the access control panel. When a packet is received from the first reader, the process first determines whether or not the packet is complete. See 305. Completeness of a data packet depends on preprogrammed criteria in the logic component. One criterion, in some embodiments, requires that the packet unambiguously identify the particular asset at issue (by providing a unique tag ID for example). Another criterion requires that a signal count be specified. If the packet is determined to be incomplete, then this process is done, and the data is ignored.

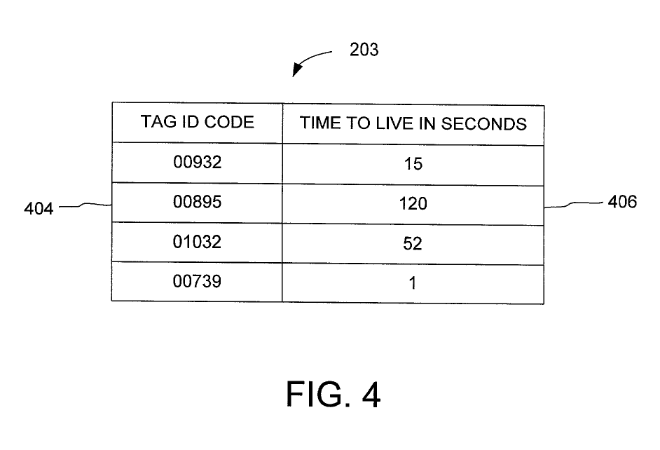

If the data packet is complete then the process converts the relevant data from the packet to an internal format useful to the converter controller. See 307. Next, at block 309, the process determines whether the controller already knows the tag ID. In one case, this involves determining whether the tag ID currently exists in an internal database. (See FIG. 4 for a representation of a simple database.) If the ID does exist, then the process resets an exit timer. See 317. This is an integral part of the aging system for the tags. If the exit timer were not periodically reset, the tag would age out or the time limit would expire and the converter controller would inform the access control panel that the tag is no longer present. Returning to process 301, if the tag ID is not known, i.e. the tag ID signal is new to the location associated with the reader under consideration, then the tag ID is added to the internal database as indicated at block 311. Next, in block 313, the process generates data indicating that an asset has arrived. It also provides this data to a format useable by the next component in the system (e.g., an access control panel). In a specific embodiment, the data is converted from the internal format to the Wiegand format. Finally, in block 315, the newly formatted packet is sent to the Wiegand in port of the access control panel. Process 301 is repeated each time the controller converter receives a data packet from the room tag reader.

FIG. 3B represents a flowchart of logic process 319 triggered by receipt of data from a second detector. In a typical embodiment, this second detector is an exit detector positioned at a room exit, for example. As illustrated, the process begins at 321 in which a packet of information from an active tag is received via an exit detector (tag reader). Once the data is received, the process determines whether or not the packet is complete at 323. Again, completeness of a data packet would depend on preprogrammed criteria in the logic device. If the packet is determined to be incomplete, then the process is done, and the data is ignored. If the data packet is complete, the process converts the relevant data to an internal format useful to the converter controller. See 325. Next, at 327, the process determines if the tag ID (or other indicator of the asset) information is already known to the system. Typically, this will involve checking the internal database or list to see if the ID currently exists. If it does not exist, then the process is complete and the data is ignored. This means that the system did not recognize the tag as present in the current location and thus signaling the access control panel that the tag is no longer present (thus “exiting”) is not appropriate. Returning to process 327, if the tag ID is known, then the tag ID is removed from the internal database or other representation in block 329. This effectively changes the state of the controller to indicate that asset is no longer in the realm of the controller. In response, the process may generate a signal to the access control panel that the tag is no longer present (or more specifically the asset is “exiting”). Next, at 331, relevant data is converted from the internal format to Wiegand format and a relevant message is generated. Finally, at 333, the newly formatted message is sent to the Wiegand out port of the access control panel. Process 319 is repeated each time the controller converter receives a data packet from the exit tag reader.

FIG. 3C presents a flowchart of a logic process 335 for aging of active tags known to the system. Typically, these are the tags that are currently recorded in a database or appropriate data structure. First, in a block 337, all active tag time values are decremented by one second. Next at 339, the activity of all tags is assessed. For all active tags, operation 337 is repeated. For all inactive tags, wherein the time has expired, the tag ID's are removed from the database. See 341. Next, at 343, the tag ID's are converted from an internal format to the Wiegand format. Finally, at 345, the newly formatted tag ID's are sent to the access control panel via the Wiegand out port.

As mentioned, processes 301, 319, and 335 are preferably asynchronous. This allows the asset management system to track assets effectively. Since signals from active tags are used as the triggers, processes 301 and 319 occur only when an active tag signals the corresponding detector. Process 335 runs continually. In this way movement of tagged assets can be monitored essentially in real time. Aging process 335 allows an added layer of security in that when asset tags are purposely hidden from the system, the invention alerts access control panels to take appropriate action after a preset time limit expires.

FIG. 4 illustrates one example a database logical structure 203 that may be used with this invention. Importantly, the database records include a Tag ID code field 404 and a time to live field 406. The Tag ID field includes values extracted from data packets sent from the active tags associated with assets. The time to live field is continually decremented (see block 337) and periodically reset (see block 317) to a particular value (e.g., 5 minutes).

One aspect of asset management in which this invention may be employed is in managing custodial relationships. In a relevant scenario, a particular person (the custodian) has authority to use or keep in her possession an asset such as a laptop computer. Either no other person or a limited number of other persons are permitted to have access to the computer. The decisional process pertaining to the condition where the custodian and the asset are in the same room can be programmed into the logic of the invention (e.g., the logic device 201 or computer 123). In one case, the system of this invention will determine that the custodial relationship is proper and so notify the access control panel. In another case, the system determines that the relationship is improper (e.g., the signals indicate that an unauthorized person is currently associated with the asset) and notifies the access control panel. The access control system can take appropriate action depending on the custodial status. In one case, perhaps to open a door that the custodian and asset are together approaching (when the person is carrying the laptop computer to the exit).

If there is a second asset, a person may have authority to possess either one, but not both, of the assets at any given time. If such person possesses both assets, then the system could signal the access control panel to turn on an alarm or lock an exit door, for example. The proximity of the two active tags assures that they both signal the same room tag reader and preprogrammed logic of the converter controller can signal the access control panel appropriately. The logic of the custodial relationships can be programmed for combinations of many different active tags and situations depending on the particular needs. A very important application for this is in child care where only certain adults could take custody of particular children.

Although the foregoing invention has been described in some detail for purposes of clarity of understanding, it will be apparent that certain changes and modifications may be practiced within the scope of the appended claims. For example, while ranging was described above, other techniques for causing modems to transmit signals at predefined frequencies and amplitudes may be employed.

What is claimed is:

1. A method of controlling assets, the method comprising:
(a) receiving a signal initiated from an active tag associated with an asset;
(b) transitioning to a state indicating that the asset is at a particular location;
(c) notifying an access control panel that the asset is in the particular location;
(d) determining that the asset is no longer in the particular location;
(e) transitioning to a state indicating that the asset is no longer in the particular location; and
(f) notifying the access control panel that the asset is no longer in the particular location.

2. The method of claim 1, wherein the active tag emits a signal periodically.

3. The method of claim 1, wherein the signal from the active tag is relayed by a reader located proximate to the particular location.

4. The method of claim 1, wherein the signal is provided in the form of a packet containing information specifying at least (i) a unique identity of the active tag and (ii) a count indicating the number of times that the active tag has emitted a signal.

5. The method of claim 1, wherein transitioning to a state indicating that the asset is at a particular location comprises creating and storing a record of the asset or changing an internal characterization of the asset.

6. The method of claim 5, further comprising resetting a time to live value in the record upon receiving a new signal initiated from the active tag.

7. The method of claim 1, further comprising: receiving a new signals initiated from the active tag while the asset is at the particular location, wherein the access control panel is notified only once while the asset is in the particular location.

8. The method of claim 1, wherein notifying the access control panel that the asset is in the particular location comprises sending a message indicating an access event, wherein the message is provided in a format that is recognized by the access control panel.

9. The method of claim 1, wherein determining that the asset is no longer in the particular location comprises:
detecting at least one of (i) a change in the signal from the active tag, and (ii) receipt of a new signal from the active tag, which new signal is conveyed by a reader at a different location.

10. The method of claim 9, wherein determining that the asset is no longer in the particular location comprises: receiving the new signal, wherein the new signal indicates that the asset has moved, or is moving, to a new location.

11. The method of claim 9, wherein determining that the asset is no longer in the particular location comprises: failure to receive the signal initiated from the active tag for more than a predetermined period of time.

12. The method of claim 1, wherein transitioning to a state indicating that the asset is no longer in the particular location comprising removing a record of the asset or changing an internal characterization of the asset.

13. The method of claim 1, wherein notifying the access control panel comprises sending a message to the access control panel in Wiegand format.

14. A method of providing asset control, the method comprising:
(a) receiving a signal initiated from an active tag associated with an asset;
(b) transitioning to a state indicating that the asset is at a particular location; and
(c) sending a message in a format that can be understood by an access control system, which message indicates that the asset is at the particular location.

15. The method of claim 14, wherein the signal from the active tag is relayed by a reader located proximate to the particular location.

16. The method of claim 14, wherein the signal is provided in the form of a packet containing information specifying at least (i) a unique identity of the active tag and (ii) a count indicating the number of times that the active tag has emitted a signal.

17. The method of claim 14, wherein transitioning to a state indicating that the asset is at a particular location comprises creating and storing a record of the asset or changing an internal characterization of the asset.

18. The method of claim 14, further comprising: receiving a new signals initiated from the active tag while the asset is at the particular location, wherein only a single message is sent to the access control system while the asset is in the particular location.

19. The method of claim 14, wherein sending a message in a format that can be understood by an access control system comprises sending a message indicating an active tag ID.

20. The method of claim 14, further comprising:
determining that the asset is no longer in the particular location; and
notifying the access control system that the asset is no longer in the particular location.

21. The method of claim 20, further comprising: transitioning to a state indicating that the asset is no longer in the particular location, after determining that the asset is no longer in the particular location.

22. The method of claim 20, wherein determining that the asset is no longer in the particular location comprises: receiving a new signal, wherein the new signal indicates that the asset has moved, or is moving, to a new location.

23. The method of claim 1, wherein the message to the access control system is provided in Wiegand format.

24. An apparatus for managing assets,
an input interface including at least two ports arranged to receive signals originating with an active tag and detected by two distinct readers;
an output interface arranged to transmit asset events indicating the state of an asset with respect to a particular location, wherein the asset events are provided in a format that can be understood by an access control system; and
a logic device that acts on the signals originating with the active tag to transition to between a first state indicating that the asset is not located at the particular location and a second state indicating that the asset is located at the particular location.

25. The apparatus of claim 24, wherein the signals originating from the active tag include information specifying at least (i) a unique identity of the active tag and (ii) a count indicating the number of times that the active tag has emitted a signal.

26. The apparatus of claim 24, further comprising a database or list identifying assets that are currently located at the particular location.

27. The apparatus of claim 26, wherein the database or list provides records comprising a first field for an asset ID or asset tag ID and second field for a time to live value.

28. The apparatus of claim 24, wherein the logic device transitions to the second state by creating and storing a record of the asset or changing an internal characterization of the asset.

29. The apparatus of claim 24, further comprising a clock signal source providing a clock signal employed by the logic device to identify assets from which no signals have been detected within a predetermined period.

30. The apparatus of claim 24, wherein the asset events are provided in the Wiegand format.

31. The apparatus of claim 24, wherein the logic device detects multiple signals originating with the active tag, but remains in the second state and provides only a single message indicating that the asset is located at the particular location.

32. The apparatus of claim 24, wherein the logic device determines that the asset is no longer in the particular location upon receiving a new signal indicating that the asset has moved, or is moving, to a new location.
